(19) United States
(12) Patent Application Publication
(10) Pub. No.: US 2022/0407987 A1
(43) Pub. Date: Dec. 22, 2022

(54) CAMERA MODULE WITH COMPONENT SIZE BASED ON IMAGE SENSOR

(71) Applicant: Meta Platforms Technologies, LLC, Menlo Park, CA (US)

(72) Inventors: Chao Han, San Ramon, CA (US); Eddie Alex Azuma, Pleasanton, CA (US); Manoj Bikumandla, Union City, CA (US); Rajendra D. Pendse, Fremont, CA (US); Cina Hazegh, Lafayette, CA (US)

(21) Appl. No.: 17/843,117

(22) Filed: Jun. 17, 2022

Related U.S. Application Data
(60) Provisional application No. 63/213,072, filed on Jun. 21, 2021.

(51) Int. Cl. H04N 5/225; H04N 5/232

(52) U.S. Cl. CPC H04N 5/2252; H04N 5/2254; H04N 5/232; H04N 5/2257

(57) ABSTRACT

A camera module includes an image sensor, a lens assembly, a printed circuit board, and a substrate. The image sensor has edges that define a two-dimensional footprint substantially parallel to a surface of the image sensor. The lens assembly is coupled to a top surface of the image sensor and focuses light onto the top surface of the image sensor. Edges of the lens assembly do not extend beyond the footprint. The printed circuit board is below the image sensor and controls the image sensor. The substrate is coupled to a bottom surface of the image sensor and to a top surface of the printed circuit board. The substrate electrically couples the image sensor to the printed circuit board. Edges of the substrate do not extend beyond the footprint.

### CROSS-REFERENCE TO RELATED APPLICATIONS

This application claims the benefit of U.S. Provisional Application No. 63/213,072, filed on Jun. 21, 2021, which is incorporated herein by reference in its entirety.

### FIELD OF THE INVENTION

This disclosure relates generally to camera modules, and more specifically to decreasing the packaging of camera modules.

### BACKGROUND

Cameras are used in various technologies, such as smartphones, tablets, augmented reality (AR) devices, and virtual reality (VR) devices. Decreasing the size of cameras reduces the size of these technologies and may make these technologies more accessible (e.g., smaller cameras may make AR or VR headsets more ergonomic). However, the conventional arrangement of cameras limits the ability to reduce their sizes. For example, conventional cameras may require a substrate that is larger than the image sensor to route traces from the image sensor to a printed circuit board.

### SUMMARY

Embodiments relate to camera modules with reduced packaging. Specifically, this disclosure describes realizations of miniaturized camera modules (including the both the components and assembly process that enable miniaturization) that can be integrated into devices (e.g., a smartphone, a tablet, or a head-mount display (HMD) unit for virtual reality (VR) or augmented reality (AR) applications) with limited space for the camera modules.

Some embodiments relate to a camera module that includes an image sensor, a lens assembly, a (e.g., flexible) printed circuit board, and a substrate. The image sensor has edges that define a two-dimensional footprint substantially parallel to a sensing surface of the image sensor. The lens assembly is coupled to a top surface of the image sensor and is configured to focus light onto the top surface of the image sensor. Edges of the lens assembly do not extend beyond the footprint. The printed circuit board is below the image sensor and is configured to control the image sensor. The substrate is coupled to a bottom surface of the image sensor and to a top surface of the printed circuit board. The substrate is configured to electrically couple the image sensor to the printed circuit board. Edges of the substrate do not extend beyond the footprint.

In some embodiments, the height of the camera module (along a z-axis) is no more than 0.4 cm, or the footprint has a length (e.g., along an x-axis) no more than 0.4 cm and a width (e.g., along a y-axis) no more than 0.4 cm.

Some embodiments relate to a camera module that includes an image sensor, a lens assembly, a (e.g., flexible) printed circuit board, and a substrate. The image sensor has edges that define a two-dimensional footprint substantially parallel to a sensing surface of the image sensor. The lens assembly is above a top surface of the image sensor and is configured to focus light onto the top surface of the image sensor. Edges of the lens assembly do not extend beyond the footprint. The printed circuit board is configured to control the image sensor. The substrate electrically couples the image sensor to the printed circuit board. The substrate is positioned between the lens assembly and the image sensor. The substrate is at least partially transparent to allow light from the lens assembly to pass through to the image sensor.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2 is a perspective view of another example wristband system, in accordance with one or more embodiments.

FIG. 3 is a diagram of a camera module, according to some embodiments.

FIG. 4 is a diagram of a camera module with a substrate that includes an interposer, according to some embodiments.

FIG. 5 illustrates a portion of a camera module that includes micro bumps or pillar bumps as interconnects between an image sensor and a substrate, according to some embodiments.

FIG. 6 illustrates a portion of a camera module that includes solder bumps as interconnects between the image sensor and the substrate, according to some embodiments.

FIG. 7 illustrates a portion of a camera module that includes passive components coupled to the bottom surface of substrate and between interconnect connections, according to some embodiments.

FIG. 8 is a diagram of a camera module with underfills, according to some embodiments.

FIG. 9A is a method for assembling a camera module, according to some embodiments.

FIG. 9B is a second method for assembling a camera module, according to some embodiments.

FIG. 9C is a third method for assembling a camera module, according to some embodiments.

FIG. 10 is a diagram of a camera module with a transparent substrate, according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

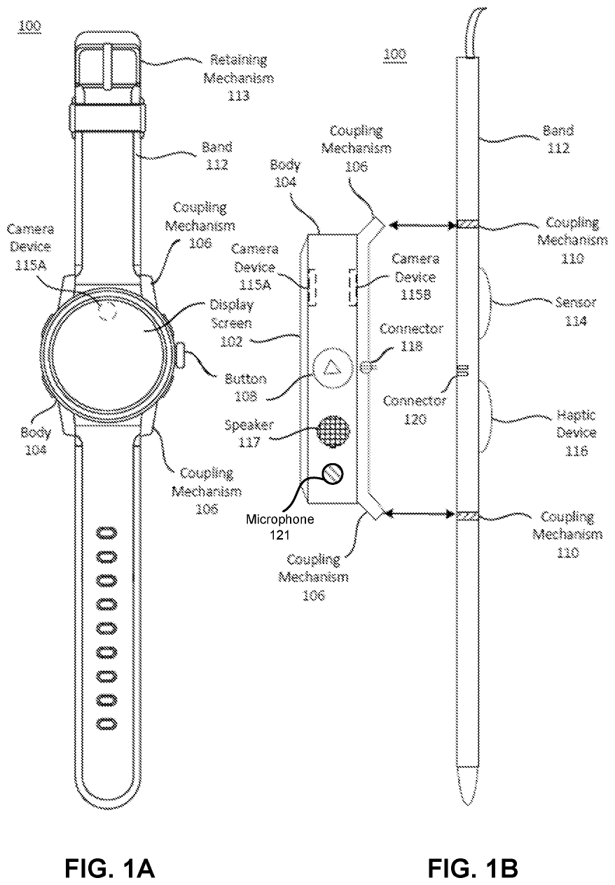

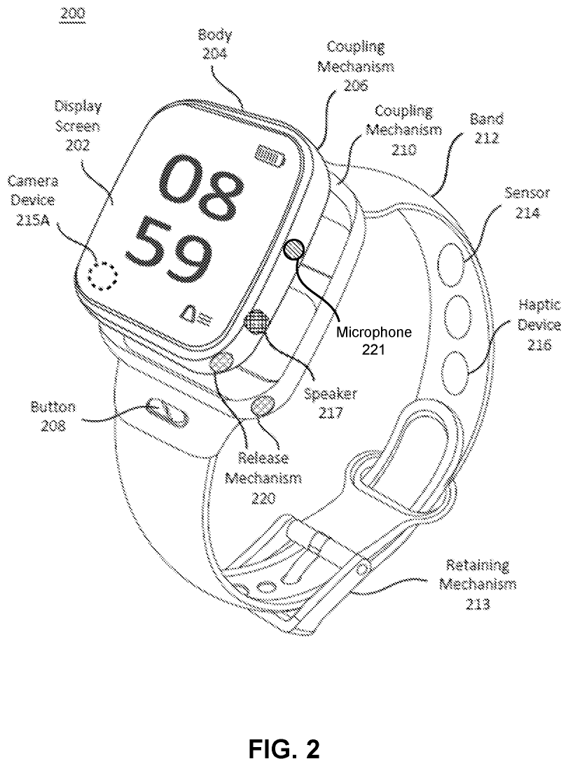

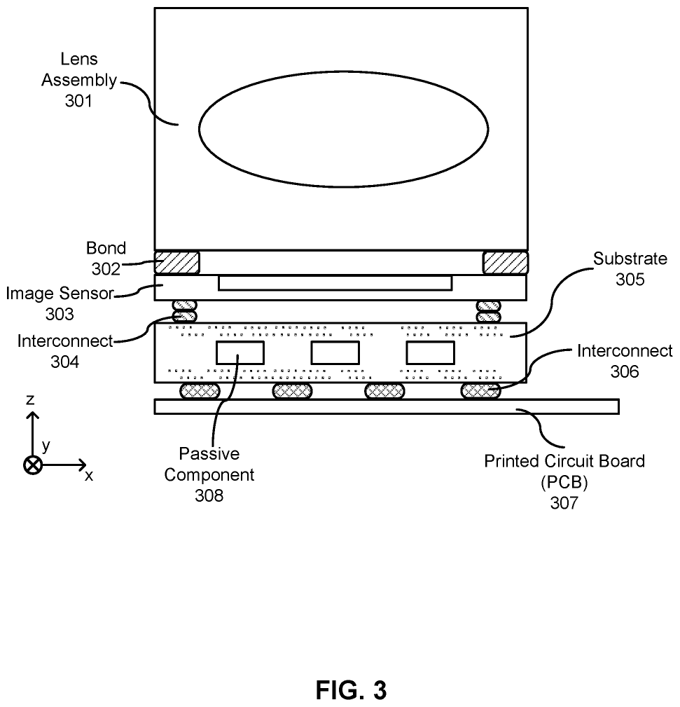

Embodiments relate to a miniaturized camera module and a method of manufacturing a militarized camera module. In various embodiments, the camera module is integrated into a mobile device, such as a smartphone, tablet, headset, or head-mounted display. Example devices are described below with respect to FIGS. 1A-2. Additional details of camera modules are described below with respect to FIGS. 3-10.

FIG. 1A is a top view of an example wristband system 100, in accordance with one or more embodiments. FIG. 1B is a side view of the example wristband system 100 of FIG. 1A. The wristband system 100 is a wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a virtual reality environment, an augmented reality environment, a mixed reality environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., CPU, memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. Embodiments of the present disclosure may orient (e.g., rotate, flip, stretch, etc.) the displayed content such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed content, pause the displaying of video content, or power down the display screen 102 when it is determined that the user is not looking at the display screen 102. In some examples, one or more sensors 114 of the wristband system 100 may determine an orientation of the display screen 102 relative to an eye gaze direction of the user.

Embodiments of the present disclosure may measure the position, orientation, and/or motion of eyes of the user in a variety of ways, including through the use of optical-based eye-tracking techniques, infrared-based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

FIG. 2 is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 of a different shape and a watch band 212 with a different layout of components (e.g., a different location for a sensor 214 and a haptic device 216 on the watch band 212). FIG. 2 illustrates a coupling mechanism 206, a camera device 215A, a display screen 202, a button 108, a speaker 117, a microphone 221, and a release mechanism 220 associated with the watch body 204. FIG. 2 illustrates a coupling mechanism 210, a retaining mechanism 213, the sensor 114, the haptic device 116, and a release mechanism 220 associated with the watch band 212. In some embodiments, another camera device may be located on an underside of the watch body 204 and is not shown in FIG. 2. In some embodiments, one or more additional sensors 214 (not shown) may be included on the watch body 204 or the watch band 212.

The one or more camera devices 115 of wristband system 100 illustrated in FIGS. 1A and 1B and the camera devices 215 of wristband system 200 illustrated in FIG. 2 may include a stabilization assembly (e.g., an optical image stabilization (OIS) assembly) internal to the camera device. The stabilization assembly is configured to adjust a positioning of one or more components of the camera devices 115, 215. In some embodiments, the stabilization assembly adjusts the positioning by utilizing augmented magnetic fields. In some embodiments, the stabilization assembly adjusts the positioning by contracting/expanding one or more shape-memory alloy (SMA) wires. In some embodiments, the stabilization assembly utilizes both augmented magnetic fields and SMA wires. These position adjustments may enable the camera devices 115, 215 to capture data describing the local area that is of a better quality. For example, the stabilization assembly may adjust the positioning of one or more lenses (or entire lens barrel) of a camera device, thus capturing better focused (more stabilized) images of the local area. As the wristband system 100 and the wristband system 200 are of a small form factor to be easily and comfortably worn on a wrist of a user, the corresponding camera devices 115, 215 and various other components of the wristband system 100 described above are designed to be of an even smaller form factor and are positioned close to each other.

FIG. 3 is a diagram of a camera module, according to some embodiments. The camera module may be an example of camera device 115 or 215. The camera module includes a printed circuit board (PCB) 307, a substrate 305, an image sensor 303, and a lens assembly 301. The substrate 305 is coupled to a top surface of the PCB 307 via interconnects (e.g., an interconnect 306). The image sensor 303 is coupled to a top surface of the substrate 305 via interconnects (e.g., the interconnect 304) and is coupled to a bottom surface of the lens assembly 301 via one or more bonds (e.g., bond 302). The camera module in FIG. 3 may include additional, fewer, or different components than illustrated. Furthermore, the space between components 301, 303, 305, and 307 is exaggerated to illustrate components 302, 304, and 306. As used herein, a “top” and “bottom” are relative to the z-axis (e.g., see coordinate system in FIG. 3).

The PCB 307 is configured to control the image sensor 303. The PCB 307 may be a flexible printed circuit board (FPC). An example PCB is a laminated sandwich structure that includes conductive and insulating layers and electronic components that form an electronic circuit. Example signals of the PCB 307 include power supply signals and I/O control signals. In some embodiments, the PCB 307 is a high-density interconnect (HDI) flex circuit that has finer design rules and can achieve smaller width and thickness.

The substrate 305 is a substrate of the image sensor 303. The substrate 305 electrically couples the image sensor 303 to the PCB 307. Said differently, the substrate 305 provides electrical connections between the image sensor 303 and the PCB 307. For example, the substrate 305 acts as an interposer that redistributes the signal traces (e.g., carrying power supply signals, data signals, and I/O control signals) from the image sensor interconnects to the PCB 307. The PCB 307 may also add mechanical strength to the camera module, as well as help with thermal dissipation of the image sensor 303. To reduce the size of the substrate 305 (e.g., so that it is no wider than the image sensor in the x and y dimensions), we can choose substrate technologies (e.g., build-up substrate or silicon substrates) that have finer design rules, and that can absorb the size of capacitors (e.g., embedded capacitors, deep trench capacitors). In the example of FIG. 3, the substrate 305 is a buildup substrate.

The substrate 305 may include one or more passive components (e.g., passive component 308). While three passive components are illustrated in the FIG. 3, in other embodiments, there may be more or less passive components. The passive components may be embedded in the substrate 305 (as opposed to being on an external surface of the substrate). In some embodiments, the passive components do not extend beyond edges of the substrate 305 or beyond edges of the image sensor 303 in the x or y dimensions. As used herein, a passive component refers to a component does not need an external power source to operate. Example passive components include sensors, voltage regulators, resistors, inductors, and (e.g., decoupling) capacitors (e.g., to reduce noise). Example embedded capacitors that may be in the substrate 305 include bypass capacitors, multilayer ceramic chip (MLCC) capacitors, metal-insulator-metal (MIM) capacitors, metal-oxide-metal (MOM) capacitors, thin film capacitors, and silicon capacitors.

The image sensor 303 is an electronic component with a sensing area configured to receive light and product a digital image of the light. Edges of the image sensor 303 define a two-dimensional footprint in the xy-plane that is substantially parallel to the sensing surface (e.g., within two degrees). In FIG. 3, the y-axis is pointed into the page. The image sensor 303 may be a bare sensor die or protected by a cover glass in a chip-scale package (CSP). Among other advantages, the image sensor 303 is manufactured such that interconnects (e.g., the interconnect 304) can be formed below the image sensor 303 to couple the image sensor 303 to the substrate 305 (instead of interconnects above the image sensor 303). This allows the top surface of the image sensor 303 to be coupled (e.g., connected) to the lens assembly 301 and may thus reduce the two-dimensional footprint of the camera module in the xy-plane. For example, if interconnects were on the top surface of an image sensor, the size of a substrate may need to be enlarged along the x or y directions to connect with the sensor pins (e.g., through wire bonding) of the image sensor. Thus, making the interconnects (e.g., 304) at the bottom surface of the image sensor 303 allows direction connection with the substrate 305 below the image sensor 303 and thus reduces the size of the camera module along the x and y directions.

In some embodiments, the image sensor 303 does not include a glass cover. This may reduce the overall thickness of the image sensor 303 (e.g., by at least 0.5 mm). This can be accomplished by protecting the active pixel array surface during the manufacturing process with a removable protective film applied at the wafer level and then removing the film prior to coupling the lens assembly 301.

The lens assembly 301 is coupled to a top surface of the image sensor 303. The lens assembly 301 is configured to focus light onto the top surface (e.g., the sensing area) of the image sensor 303. The lens assembly 301 may include an integrated filter. The lens assembly 301 may be coupled (e.g., connected) to the image sensor 303 via glue bonds 302. To reduce the size of the camera module, it may be desirable for the lens assembly 301 to be as small as possible, while still focusing light onto the image sensor 303.

The interconnects (e.g., 304 and 306) allow couplings of the PCB 307 and the image sensor 303 to the substrate 305 without adding additional x or y space to the camera module. More specifically, the interconnects physically and electrically couple the PCB 307 and the image sensor 303 to the substrate 305. The interconnects coupling substrate 305 to PCB 307 (e.g., including 306) may be formed using an anisotropic conductive film (ACF) or a hot bar process. The type of interconnect may be chosen to help reduce the size of the camera module (e.g., to reduce the two-dimensional footprint of the image sensor 303). The interconnects (e.g., 304 and 306) may be fine pitch interconnects, such as C4 bumps, fine pitch C4 bumps, micro C4 bumps, Cu pillar bumps, bump-less interconnects (e.g., Cu-to-Cu diffusion bonding), or stud bumps. In some embodiments, interconnects coupling image sensor 303 to substrate 305 (e.g., including 304) may include gold stud bumps. In these embodiments, the gold stud bumps may be located outside of the sensing area of the image sensor 303 to avoid or prevent damage to the sensing area during a bonding process (e.g., a thermosonic bonding process). Said differently, the gold stud bumps may not be below the sensing area of the image sensor 303.

In some embodiments, the size of a camera module may be based on the size of the image sensor 303. More specifically, the sizes of individual components (e.g., 301 and 305) may be based on the size of the image sensor 303. For example, the length of the substrate 305 (or the lens assembly 301) along the x-dimension is equal to or less than the length of the image sensor 303 along the x-dimension. Similarly, the length of the substrate 305 (or the lens assembly 301) along the y-dimension may be equal to or less than the length of the image sensor 303 along the y-dimension. In another example, the two-dimensional footprint of the substrate 305 (or the lens assembly 301) in the xy-plane does not extend beyond the two-dimensional footprint of the image sensor 303 in the xy-plane. In another example, one or more edges of the substrate 305 (or the lens assembly 301) do not extend beyond the two-dimensional footprint of the image sensor 303 in the xy-plane. In another example, edges of the substrate 305 (or the lens assembly 301) enclose an area equal to or smaller than the area enclosed by the two-dimensional footprint of the image sensor in the xy-plane.

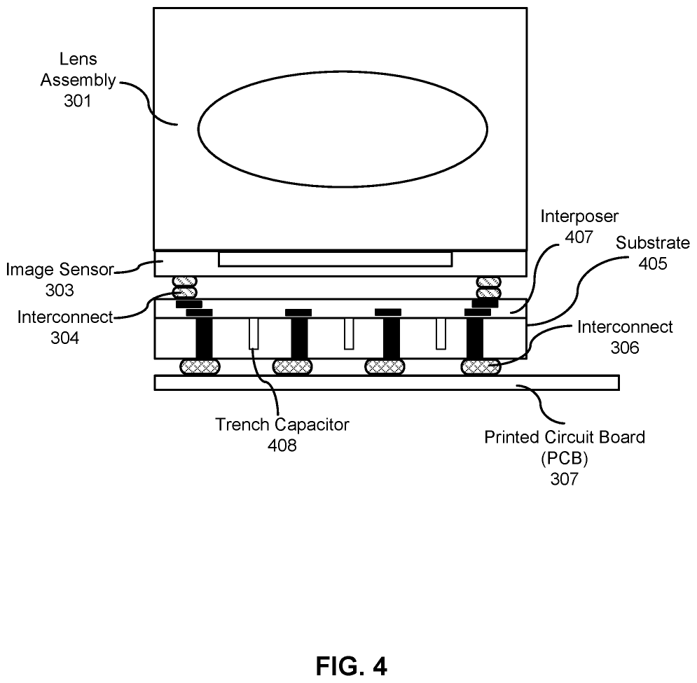

FIG. 4 is a diagram of a camera module with a substrate 405 that includes an interposer 407, according to some embodiments. The camera module in FIG. 4 may include additional, fewer, or different components than illustrated. Furthermore, similar to the description of FIG. 3, the space between components 301, 303, 405, and 307 is exaggerated.

In the example of FIG. 4, the substrate 405 is a silicon substrate. The horizontal black rectangles in the interposer 407 represent redistribution layers (RDL) and the vertical black rectangles below the interposer 407 represent through silicon vias (TSV). The interposer 407 may have a special design to meet signal integrity requirements of the image sensor 303 of the camera module. Among other advantages, an interposer (e.g., 405) may have smaller trace widths (e.g., between 0.005 mm and 0.01 mm) and smaller spacing between traces (e.g., between 0.005 mm and 0.01 mm) compared to organic PCB substrates or ceramic substrates. Thus, an interposer may help the camera module have a smaller two-dimensional footprint in the xy-plane.

Additionally, the substrate 405 of FIG. 4 includes three (e.g., deep) trench capacitors (408 is labeled in FIG. 4). (Embedded capacitors are typically ceramic-based capacitors that are discrete components, while deep trench capacitors are directly fabricated on a (e.g., silicon) substrate using a semiconductor process.) However, interposer 405 may include additional or fewer trench capacitors. Trench capacitors may also contribute to reducing the two-dimensional footprint of the camera module in the xy-plane.

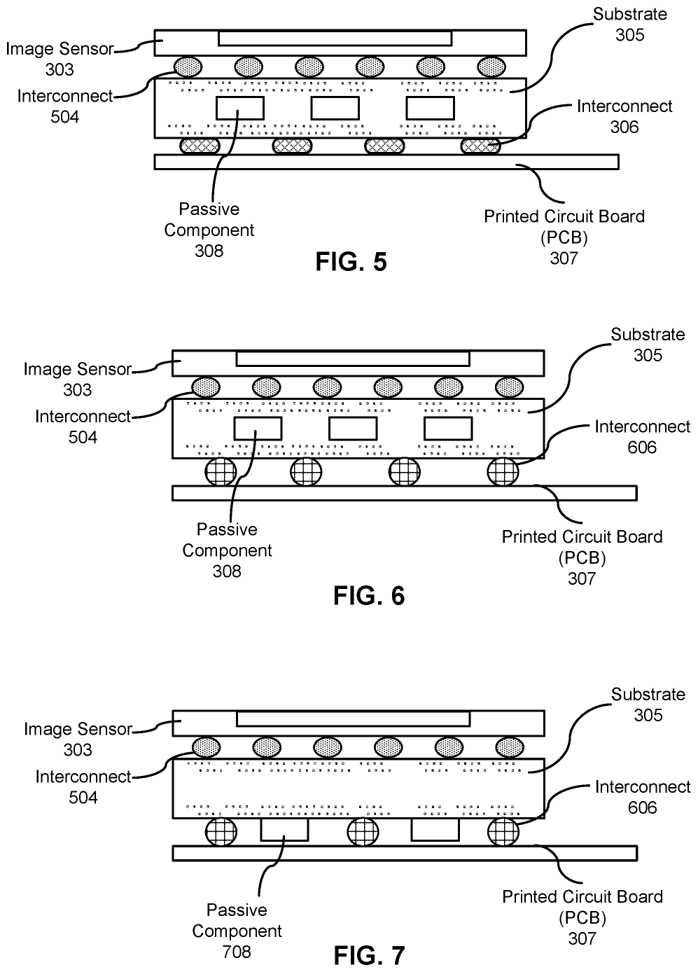

FIGS. 5-7 are diagrams of portions of camera modules with different interconnects and passive components, according to some embodiments. The different features in FIGS. 5-7 may be used in combination with other features in other embodiments. For example, a camera module may include passive components 308 and 708.

FIG. 5 illustrates a portion of a camera module that includes micro bumps or pillar bumps as interconnects between the image sensor 303 and the substrate 305, according to some embodiments. FIG. 5 is a diagram similar to FIG. 3, except in FIG. 5 the interconnects (e.g., interconnect 504) between the image sensor 303 and the substrate 305 are micro bumps or pillar bumps (and the lens assembly 301 is not illustrated for simplicity). The micro bumps or pillar bumps couple the image sensor 303 to the substrate 305. Micro or pillar bumps may offer small pitches (e.g., 20-60 μm).

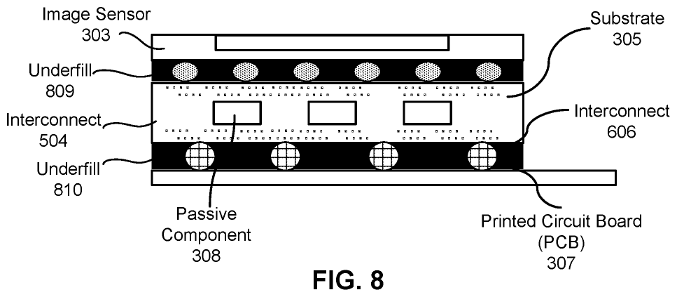

FIG. 6 illustrates a portion of a camera module that includes solder bumps as interconnects between the image sensor 303 and the substrate 305, according to some embodiments. FIG. 6 is a diagram similar to FIG. 5, except the interconnects (e.g., interconnect 606) between the substrate 305 and the PCB 307 are solder bumps. The solder bumps couple the substrate 305 to the PCB 307. Solder bumps may offer pitches ˜100 μm.

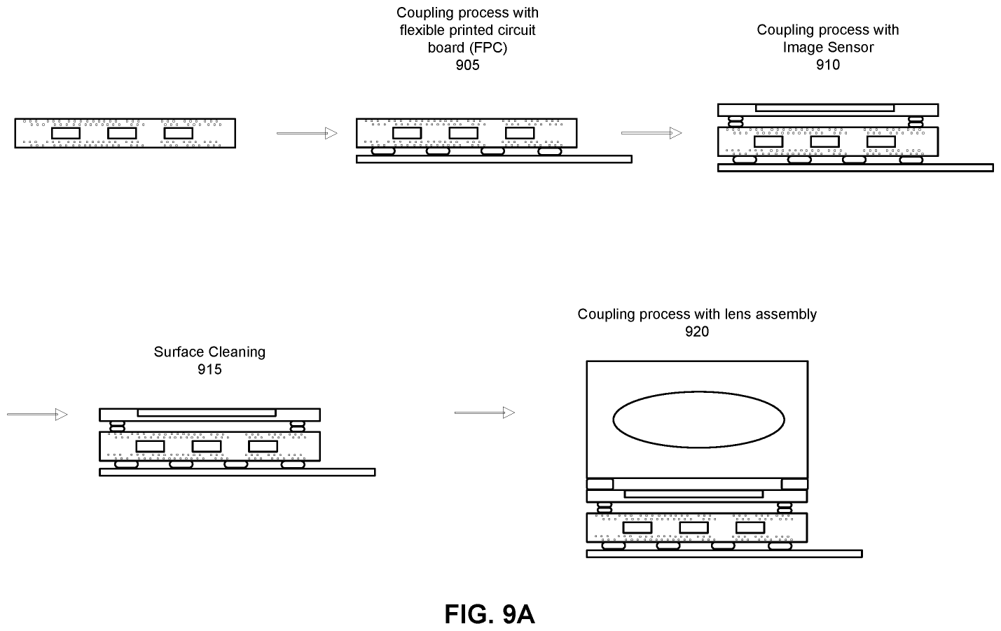

FIG. 7 illustrates a portion of a camera module that includes passive components coupled to the bottom surface of substrate 305 and between interconnect connections, according to some embodiments. FIG. 7 is a diagram similar to FIG. 6, except the passive components (e.g., passive component 708) is coupled to the to the bottom surface of substrate 305 and between interconnect connections. These passive components may further reduce the two-dimensional footprint of the camera module in the xy-plane. While two passive components coupled to the bottom surface of substrate 305 are illustrated in the FIG. 7, in other embodiments, there may be more or less passive components. A passive component (e.g., 708) coupled to the bottom surface of substrate 305 may be a land side capacitor. Example land side capacitors include multilayer ceramic chip (MLCC) capacitors, metal-insulator-metal (MIM) capacitors, metal-oxide-metal (MOM) capacitors, thin film capacitors, and silicon capacitors.

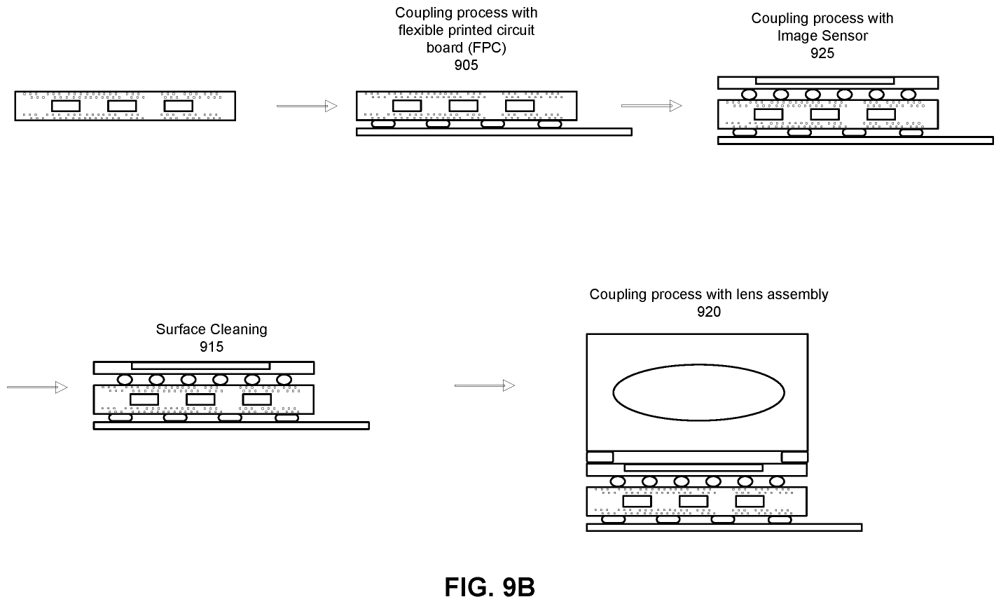

FIG. 8 is a diagram of a portion of a camera module with underfills, according to some embodiments. More specifically, FIG. 8 is a diagram similar to FIG. 6, except FIG. 8 additionally includes underfill 809 and underfill 810. Underfill 809 is an underfill between image sensor 303 and substrate 305. Underfill 810 is an underfill between substrate 305 and PCB 307. The underfills may be epoxy materials or capillary underfills. The underfills may improve the strength and reliability of the camera module. The camera module in FIG. 8 may include additional, fewer, or different components than illustrated.

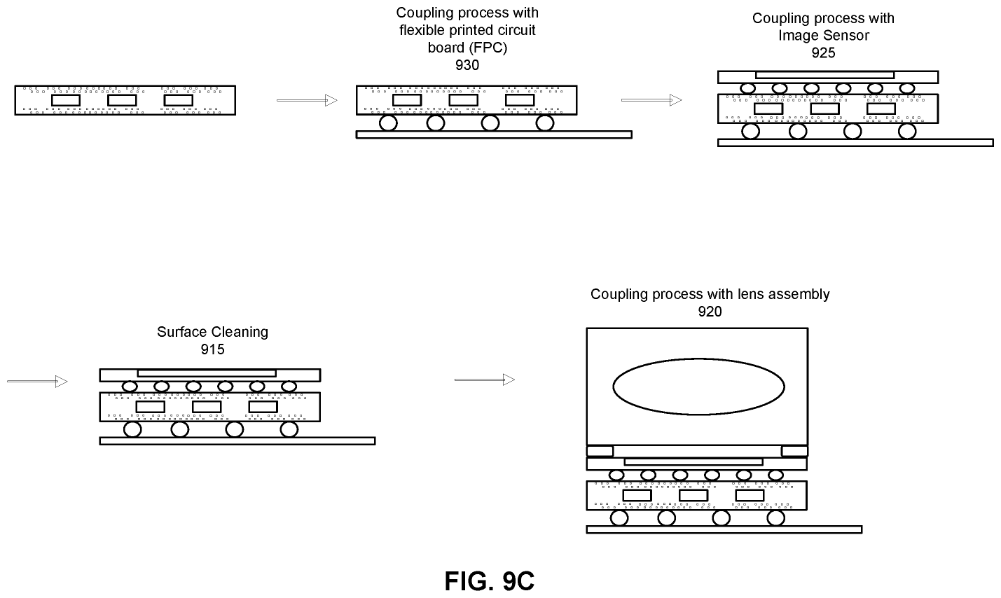

FIGS. 9A-9C are flow charts illustrating methods for assembling camera modules, according to some embodiments. The steps of the methods may be performed in different orders, and the methods may include different, additional, or fewer steps.

FIG. 9A is a method for assembling a camera module, according to some embodiments. The method may be part of a camera module manufacturing process, for example, to manufacture the camera module in FIG. 3 or 4.

A coupling process is performed 905 to couple a substrate (e.g., 305) to an PCB (e.g., 307). For example, interconnects (e.g., 306) are formed between the substrate and the PCB. The coupling process may be an ACF process, which is a thermal compression process. Among other advantages, the ACF process is performed early in the method (e.g., before the image sensor or lens assembly are coupled). This avoids exposing the image sensor and lens assembly to mechanical stress (e.g., via the heat and pressure) that may occur from the ACF process. In some embodiments, the ACF process is modified to account for the small sizes of the components.

A coupling process is performed 910 to couple the substrate to an image sensor (e.g., 303). For example, interconnects (e.g., 304) are formed between the substrate and the image sensor. The coupling process may be a flip chip process that forms stud bumps.

A coupling surface of the image sensor may be cleaned 915 in preparation to couple the image sensor to a lens assembly (e.g., 301). A coupling surface of the lens assembly may also be cleaned. A coupling surface refers to a surface (or a portion of a surface) that will couple to another component. The cleaning process may clean any contamination or debris between the image sensor and the lens assembly that may compromise the coupling between the image sensor and the lens assembly. In some embodiments, a coupling surface is protected during the previous steps to avoid contamination or debris.

A coupling process is performed 920 to couple the image sensor to the lens assembly. The coupling process may include an active alignment step. In some embodiments, the glue dispense process of the active alignment is modified to achieve thin bond lines (e.g., <200 μm) for the small size of the camera module. Grip fixtures (used during the active alignment process) may also need to be modified since the lens assembly and substrate are so small. Among other advantages, the lens assembly is attached near the end of the process, thus reducing the likelihood of damaging the lens assembly during other steps of the process.

In some embodiments, the entire stack (the image sensor and substrate including the interconnect and passive components) can be built on the image sensor wafer back side as an extension of the wafer level CSP process (before the CSP is singulated). This can eliminate the separate substrate and bonding of the CSP to the substrate.

FIG. 9B is a second method for assembling a camera module, according to some embodiments. The method of FIG. 9B is similar to the method in FIG. 9A, except step 910 is replaced with step 925. The method of FIG. 9B may be part of a camera module manufacturing process, for example, to manufacture the camera module in FIG. 5.

Step 925 is a coupling process to couple the substrate to an image sensor (e.g., 303). For example, interconnects (e.g., 504) are formed between the substrate and the image sensor. The coupling process may be an SMT (surface mount technology) process. The SMT process may include a modified fixture design to apply solder flux to one or both of the small coupling surfaces. During the SMT process, one or more top surfaces (e.g., coupling surfaces) of the image sensor may be protected (e.g., using a removable cap or tape) to avoid contamination that may result due to the SMT process. Among other advantages, the SMT process is performed early in the method (e.g., before the lens assembly is coupled). This avoids exposing the lens assembly to mechanical stress (e.g., via the heat and pressure) that may occur from the SMT process.

FIG. 9C is a third method for assembling a camera module, according to some embodiments. The method of FIG. 9C is similar to the method in FIG. 9B, except step 905 is replaced with step 930. The method of FIG. 9C may be part of a camera module manufacturing process, for example, to manufacture the camera module in FIG. 6.

Step 930 is a coupling process to couple the substrate to an PCB (e.g., 307). For example, interconnects (e.g., 606) are formed between the substrate and the PCB. The coupling process may be an SMT process. Among other advantages, an SMT process may provide less mechanical stress compared to an ACF process.

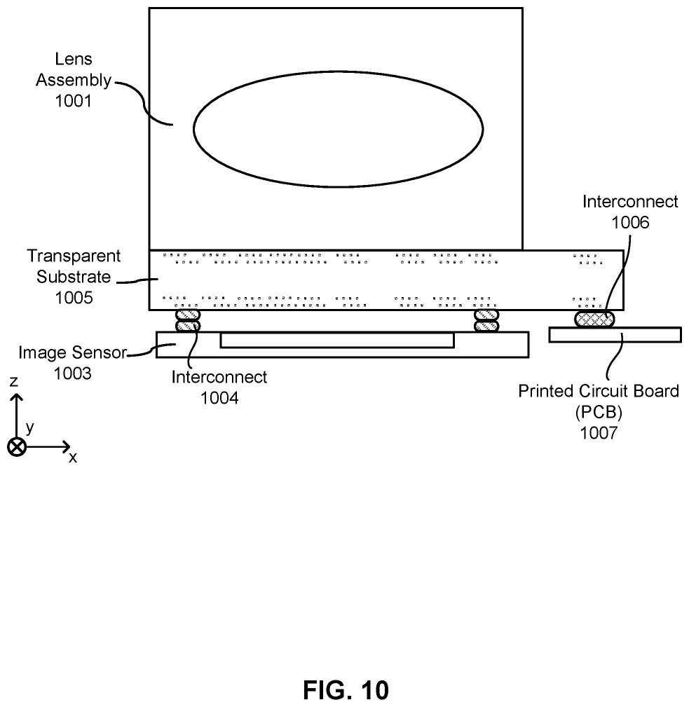

FIG. 10 is a diagram of a camera module with a transparent substrate 1005, according to some embodiments. The transparent substrate 1005 is coupled (e.g., via a bond) to a bottom surface of the lens assembly 1001. The image sensor 1003 and PCB 1007 are below the transparent substrate 1005. The image sensor 1003 is coupled a bottom surface of the transparent substrate 1005 via interconnect 1004 (because of this, the interconnect 1004 is on the top surface of the image sensor 1003). The PCB 1007 is coupled to a bottom surface of the transparent substrate 1005 via interconnect 1006. Although the PCB 1007 is coupled to the bottom side of the transparent substrate 1005 in FIG. 10, in other embodiments, the PCB 1007 may be coupled to a top side of the transparent substrate 1005. The image sensor 1003 and PCB 1007 may have similar functionalities as image sensor 303 and PCB 307 described above. Thus, descriptions of image sensor 1003 and PCB 1007 are omitted here for brevity. Although not illustrated, the camera module in FIG. 10 may include passive components, for example, coupled (e.g., mounted) to the PCB 1007. The camera module in FIG. 10 may include additional, fewer, or different components than illustrated.

As the name suggests, the transparent substrate 1005 is at least partially transparent so that light can pass through it. For example, the transparent substrate 1005 is a glass substrate with traces (e.g., coated, embedded, or recessed on it) and through-glass vias. The transparent substrate 1005 may be transparent enough to allow light from the lens assembly 1001 to pass through and be captured by the image sensor 1003. For example, the transparent substrate 1005 is transparent enough that the image sensor 1003 captures images at least at a predetermined level of resolution (e.g., at least >50% transparency). To do this, the traces or vias of the transparent substrate 1005 may be small or spaced apart. Additionally, or alternatively, the traces or vias may be arranged along edges to reduce the amount of light blocked by these components. In some embodiments, the traces are transparent. Additionally, or alternatively, the traces may be outside of the optical pathway of light directed to the sensing area of the image sensor 1003.

In some embodiments, the transparent substrate 1005 is integrated into or part of the lens assembly 1001. In these embodiments, the substrate 705 may include a curvature or a lens element to direct light (e.g., refract light) toward the image sensor 1003. In some embodiments, the lens assembly 1001 or the transparent substrate 1005 may include a light filter (e.g., integrated into it) to filter out unwanted light wavelengths.

Among other advantages, the transparent substrate 1005 of FIG. 10 may reduce the height (along the z-axis) of the camera module. If the transparent substrate 1005 is integrated into or part of the lens assembly 1001, this may reduce the number of components and complexity of the camera module as well.

### Additional Configuration Information

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for universal vehicle control through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A camera module comprising:
an image sensor with edges that define a two-dimensional footprint substantially parallel to a sensing surface of the image sensor;
a lens assembly coupled to a top surface of the image sensor and configured to focus light onto the top surface of the image sensor, wherein edges of the lens assembly do not extend beyond the footprint;
a printed circuit board below the image sensor and configured to control the image sensor; and
a substrate coupled to a bottom surface of the image sensor and to a top surface of the printed circuit board, the substrate configured to electrically couple the image sensor to the printed circuit board, wherein edges of the substrate do not extend beyond the footprint.

2. The camera module of claim 1, wherein edges of the substrate enclose an area equal to or smaller than the area enclosed by the footprint.

3. The camera module of claim 1, wherein edges of the lens assembly enclose an area equal to or smaller than the area enclosed by the footprint.

4. The camera module of claim 1, wherein the substrate is electrically coupled to the bottom surface of the image sensor via substrate interconnects.

5. The camera module of claim 4, wherein the substrate interconnects include gold stud bumps, micro bumps, or pillar bumps.

6. The camera module of claim 1, wherein the substrate is coupled to the top surface of the printed circuit board via substrate interconnects.

7. The camera module of claim 6, wherein the substrate interconnects are anisotropic conductive film (ACF) interconnects or solder bumps.

8. The camera module of claim 1, wherein a height of the camera module is not more than 0.4 cm.

9. The camera module of claim 1, wherein the footprint has a length no more than 0.4 cm and a width no more than 0.4 cm.

10. The camera module of claim 1, further comprising passive electrical components electrically coupled to the image sensor.

11. The camera module of claim 10, wherein the passive electrical components include a capacitor embedded in the substrate and electrically coupled to the image sensor.

12. The camera module of claim 10, wherein the passive electrical components include a component coupled to a bottom side of the substrate, the component being between substrate interconnects that couple a bottom surface of the substrate to the top surface of the printed circuit board.

13. The camera module of claim 10, wherein the passive electrical components include at least one of: a multilayer ceramic chip (MLCC) capacitor, a metal-insulator-metal (MIM) capacitor, a metal-oxide-metal (MOM) capacitor, a thin film capacitor, or a silicon capacitor.

14. The camera module of claim 1, wherein the substrate is a build up substrate.

15. The camera module of claim 1, wherein the substrate includes a silicon interposer.

16. The camera module of claim 15, wherein the silicon interposer includes a trench capacitor electrically coupled to the image sensor.

17. The camera module of claim 15, wherein the substrate includes through silicon vias (TSVs) that electrically couple the image sensor to the printed circuit board.

18. The camera module of claim 15, wherein the substrate includes a redistribution layer (RDL).

19. A camera module comprising:
an image sensor with edges that define a two-dimensional footprint substantially parallel to a sensing surface of the image sensor;
a lens assembly above a top surface of the image sensor and configured to focus light onto the top surface of the image sensor, wherein edges of the lens assembly do not extend beyond the footprint;
a printed circuit board configured to control the image sensor; and
a substrate that electrically couples the image sensor to the printed circuit board, the substrate positioned between the lens assembly and the image sensor and being at least partially transparent to allow light from the lens assembly to pass through to the image sensor.

20. The camera module of claim 19, wherein traces of the substrate are at least partially transparent.
